(19) United States
(12) Patent Application Publication
(10) Pub. No.: US 2020/0234677 A1
(43) Pub. Date: Jul. 23, 2020

(54) DISPLAY LIGHTING APPARATUS AND CONTROL METHOD THEREFOR

(71) Applicant: Rohinni, LLC, Coeur d'Alene, ID (US)

(72) Inventors: Cody Peterson, Hayden, ID (US); Andrew Huska, Liberty Lake, WA (US)

(21) Appl. No.: 16/746,715

(22) Filed: Jan. 17, 2020

Related U.S. Application Data
(60) Provisional application No. 62/794,351, filed on Jan. 18, 2019.

(51) Int. Cl. G09G 5/10; G06F 1/18

(52) U.S. Cl. CPC G09G 5/10; G09G 2330/021; G09G 2320/0633; G06F 1/189

(57) ABSTRACT

A display device includes lighting elements and/or circuit arrangements including lighting elements that are configured to, at a predetermined time, receive a boost of stored energy and emit a brightness level greater than the brightness level that is emitted with the use of the lighting elements and/or circuit arrangements when not using the stored energy.

### CROSS REFERENCE TO RELATED PATENT APPLICATIONS

This application claims priority to U.S. Provisional Patent Application No. 62/794,351, filed Jan. 18, 2019, entitled “Display Lighting Apparatus and Control Method Therefore” and incorporates U.S. patent application Ser. No. 14/939,896, filed on Nov. 12, 2015, entitled “Apparatus for Transfer of Semiconductor Devices,” now issued as U.S. Pat. No. 9,633,883, in its entirety by reference.

### BACKGROUND

Display devices include televisions, laptops, monitors, tablet devices and computers, portable phones, wearable devices, etc. Many, if not all, modern display devices are capable of displaying high resolution images, whether video or still images. Due to encoding limitations and other electrical considerations, such as heat build-up and dissipation or power provision and distribution matters, images may not display with the same effect, either for the image itself or for a user seeing the image, as originally conceived or desired. That is, while the technology for display devices has undoubtedly increased beyond imagination from where it was in the last century, creators and consumers of cinematography and photography may still desire additional capabilities for unique display experiences.

Moreover, as technology for providing the illumination for the display devices improves, changes may be made to deliver a desired image according to the changes in the lighting elements.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates a schematic of a function of a circuit according to an embodiment of the instant disclosure.

FIG. 2 illustrates an example overlay of graphical results of a function according to an embodiment of the instant disclosure.

FIG. 3 illustrates an example display device according to an embodiment of the instant disclosure.

### DETAILED DESCRIPTION

### Overview

This disclosure is directed to display devices and the effect of enhancing the power drive to lighting elements of the display devices that illuminate the images displayed for a targeted display of extra brightness depending on the image displayed on the display device.

Lighting elements contemplated for inclusion in the instant disclosure include, but are not limited to: LED, microLED (i.e., having a lateral dimension ranging from about 50 microns to about 400 microns and height dimension ranging from about 10 microns to about 100 microns), OLED, light sources implanting quantum dots, QLED, etc. Potential implementations of the technology disclosed herein include, but are not limited to: systems for use in a display device, a display device itself, a circuit arrangement, a supplemental battery storage system, and a software and/or hardware use.

### Illustrative Embodiments

In an embodiment, a system for energy storage may include a display for smart video/still image playback and/or recording, in which a power supply allows a controller of the display device to overdrive extra power from a power storage unit directly to the lighting elements and/or circuit components connected to the lighting elements. This is done to initiate heightened or enhanced levels of brightness in predetermined scenes or images (e.g., explosions, sunrises, etc.). Such enhanced brightness levels would normally not be possible due to instantaneous power supply limitations from the electric supply available at the primary power source (e.g., a hardwire connected power outlet, a built-in battery, an external battery backup, etc.). The system for energy storage may include: a built-in/internal or an external battery (wired or integrated directly), super capacitors, a secondary power supply source directed to a connected power storage unit, etc. Furthermore, the system may include intelligent control features integrated into the controller that execute steps to deploy the stored energy to ensure that the boosted power is provided whenever enhanced illumination is initiated.

In an embodiment, a system according to the instant disclosure includes a hardware system, a software system, or a combination hardware and software system. The system may be implemented in a display device.

In an embodiment, a display device may include lighting elements and/or circuit arrangements including lighting elements. The lighting elements are configured to, at a predetermined time, receive a boost of energy from an energy storage unit to power the lighting elements and/or circuit arrangements including lighting elements to a level beyond that of the amount of power otherwise available from the primary supply source.

In an embodiment, a display device may include lighting elements and/or circuit arrangements including lighting elements that are configured to, at a predetermined time, receive a boost of stored energy and emit a brightness level greater than the brightness level that is emitted with the use of the lighting elements and/or circuit arrangements when not using the stored energy.

In an embodiment, a display device according to the above description includes portable and stationary televisions, laptops, monitors, tablet devices and computers, portable phones, wearable devices, etc.

In an embodiment, lighting elements are configured to, at a predetermined time, receive a boost of energy from an energy storage unit to power the lighting elements and/or circuit arrangements including lighting elements to a level beyond that of the amount of power otherwise available from the primary supply source.

In an embodiment, a circuit arrangement is configured to, at a predetermined time, receive a boost of energy from an energy storage unit to power lighting elements and/or circuit arrangements including lighting elements to a level beyond that of the amount of power otherwise available from the primary supply source.

In an embodiment, a software update for pre-existing display devices is contemplated to be uploaded to integrate with the control instructions in a pre-existing display device to update the display device to enable lighting elements of the display device to, at a predetermined time, receive a boost of energy from an energy storage unit to power lighting elements and/or circuit arrangements including lighting elements to a level beyond that of the amount of power otherwise available from the primary supply source.

In an embodiment, a software implementation for new display devices is encoded in the control instructions for a newly-manufactured display device to enable lighting elements of the display device to, at a predetermined time, receive a boost of energy from an energy storage unit to power lighting elements and/or circuit arrangements including lighting elements to a level beyond that of the amount of power otherwise available from the primary supply source.

In an embodiment, an external, supplemental battery storage may include one or more processors having instructions stored in a memory associated therewith. The one or more processors may be configured to integrate with a pre-existing display device or a new display device to enhance control of lighting elements of the display device to enable the lighting elements of the display device to, at a predetermined time, receive a boost of energy from an energy storage unit to power lighting elements and/or circuit arrangements including lighting elements to a level beyond that of the amount of power otherwise available from the primary supply source.

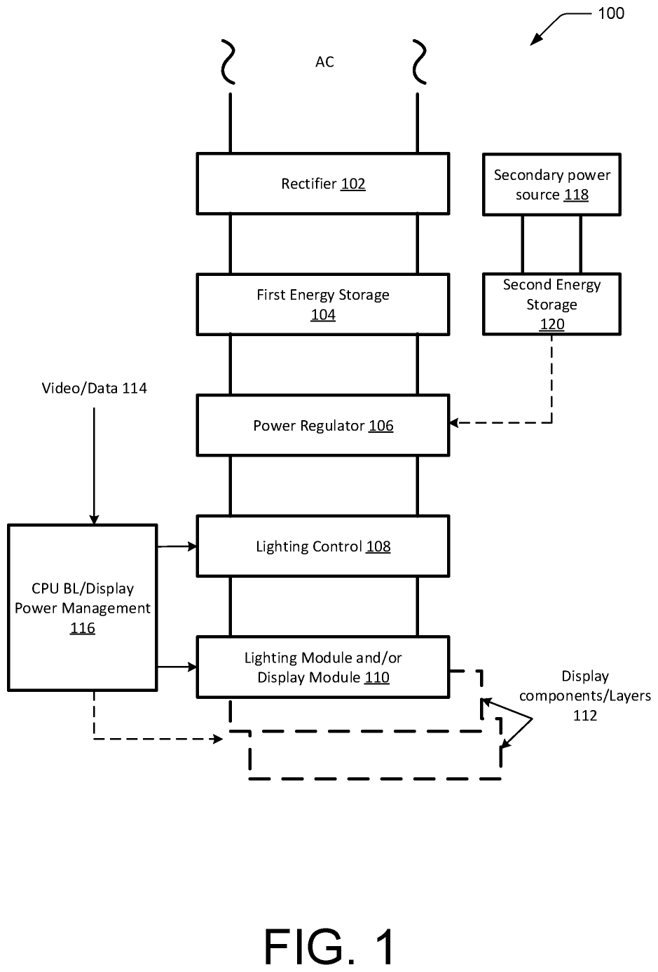

As depicted in FIG. 1, a schematic of a system 100 with respect to the function described above according to an embodiment. System 100 may include circuit components and power componentry illustrated, as follows. That is, system 100 may include a rectifier 102 configured to receive AC power. After passing through the rectifier 102, the power may enter a first energy storage 104, which is a standard energy storage for a conventional display device. Power may then pass from the first energy storage 104 to a power regulator 106 before being distributed to through a lighting control 108, which controls the amount of power allotted to various light sources in a lighting module and/or display module 110. Note, FIG. 1 also depicts potential (hence the hashed outlines) additional display components/layers 112 of the lighting module and/or display module 110.

As power from the primary source (AC) is flowing through the system 100, video/data 114 is being received by the central processing unit (“CPU”) 116 for brightness level (“BL”) and display power management. This video/data 114 is filtered through CPU 116 to provide instructions to both the lighting control 108 and the lighting module and/or display module 110 (and potentially to the other display components/layers 112), whereby the correct BL level is displayed.

In the event an enhanced amount of BL is requested in the video/data 114, system 100 may further include a secondary power source 118, such as a battery. Power may be pulled from the secondary power source 118 to a second energy storage 120, such as a capacitor or hybrid capacitor. The power pulled from second energy storage 120 may be passed to the power regulator 106, which then distributes the additional power that had been stored according to the enhanced BL to the lighting control 108, as requested in the signal instructions from the CPU 116.

Thus, system 100 is configured to function such that the additional battery or secondary power source that provides the energy beyond that which is capable of being instantly drawn from the primary source, may be connected to be regulated by the power management control and released depending on the video/data feed to the controller indicating that a surge is requested for a brightness level exceeding that of normal power levels deliverable from the primary source.

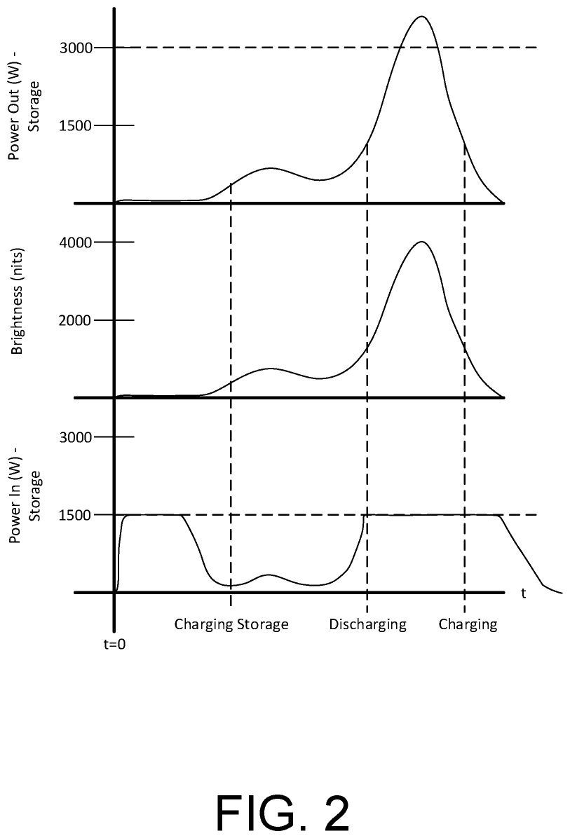

For example, (as illustrated in FIG. 2 by the overlaid graphs of power in, from the primary source, brightness level, and power out, from the primary and secondary storage energy available) a TV that is not configured with the features of the instant disclosure may only be capable of providing a power level that allows the light source(s) to produce (e.g., discharge power to cause the light sources to illuminate) a brightness level of 2000 nits (or 200 nits). In contrast, due at least in part to the power supplied by the secondary power supply of the instant disclosure, a TV with such a feature may provide a brightness level of 4000 nits (or 400 nits) or greater. That is, the secondary power boost release may increase the brightness level of the light sources as high as double or more. Although, less than double the brightness may be desirable as well, which may be regulated according to the data received.

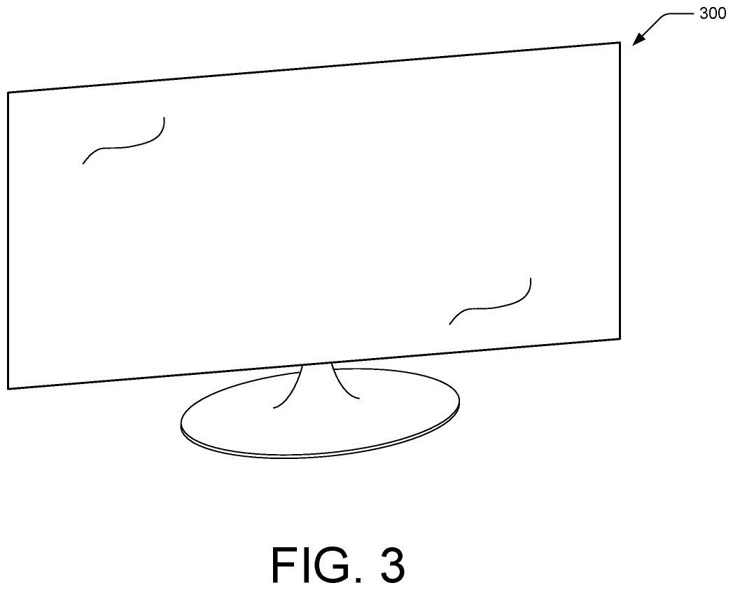

FIG. 3 depicts a potential display device, such as a TV. Other display devices are contemplated.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

1. A display device comprising:
lighting elements; and
a power storage unit configured to deliver a boost of power to one or more of the lighting elements to illuminate the one or more lighting elements to a boosted level of illumination beyond a primary level of illumination that is used when using an amount of power otherwise available from a primary power supply source.

2. The display device according to claim 1, wherein the boost of power is sourced from a secondary power supply source.

3. The display device according to claim 2, wherein the secondary power supply source is a storage power supply electrically dedicated to instantaneously provide additional power for boosting the illumination of the one or more of the lighting elements without diminishing an amount of the power from the primary power supply source.

4. The display device according to claim 1, further comprising a control unit configured to determine when to deliver the boost of power.

5. The display device according to claim 4, wherein a determination of when to deliver the boost of power is determined at least in part based on display data provided to the control unit.

6. The display device according to claim 1, a timing of delivery of the boost of power is determined at least in part based on scene data for display, the scene data indicating initiation of enhanced brightness.

7. The display device according to claim 6, wherein the scene data indicating the initiation of the enhanced brightness includes a scene displaying one or more of an explosion, a sunrise, or a bright light.

8. The display device according to claim 1, further comprising a secondary power supply source to provide the boost of power, the secondary power supply source including one or more of an internal battery, an external battery, or a super capacitor.

9. The display device according to claim 1, wherein the display device is a display screen incorporated in one or more of: a portable television, a stationary television, a laptop, a monitor, a tablet device, a computer, a portable phone, or a wearable device.

10. A display device including a primary power supply source, the display device comprising:
a control system to control:
lighting elements that are powered, at least in part, by the primary power supply source, and
a power storage unit configured to illuminate one or more of the lighting elements to a boosted level of illumination beyond a threshold level of illumination, the boosted level of illumination being achieved using a first amount of power that is greater than a second amount of power,
wherein the first amount of power includes a combination of power stored in a storage power supply and power available from the primary power supply source, and
wherein the second amount of power includes the power available from the primary power supply source.

11. The display device according to claim 10, wherein the storage power supply is sourced from a secondary power supply source.

12. The display device according to claim 11, wherein the secondary power supply source is a storage power supply electrically dedicated to instantaneously provide additional power for boosting the illumination of the one or more of the lighting elements without diminishing an amount of the power from the primary power supply source.

13. The display device according to claim 10, wherein the control system is further configured to control when to deliver the boosted level of illumination.

14. The display device according to claim 13, wherein a determination of when to deliver the boosted level of illumination is determined at least in part based on display data provided to the control system.

15. The display device according to claim 10, a timing of delivery of the boosted level of illumination is determined at least in part based on scene data for display, the scene data indicating initiation of enhanced brightness.

16. The display device according to claim 15, wherein the scene data indicating the initiation of the enhanced brightness includes a scene displaying one or more of an explosion, a sunrise, or a bright light.

17. The display device according to claim 10, further comprising a secondary power supply source to provide the boosted level of illumination, the secondary power supply source including one or more of an internal battery, an external battery, or a super capacitor.

18. The display device according to claim 10, wherein the display device is a display screen incorporated in one or more of: a portable television, a stationary television, a laptop, a monitor, a tablet device, a computer, a portable phone, or a wearable device.

19. The display device according to claim 10, wherein the boosted level of illumination doubles an amount of a brightness level of a scene being displayed compared to a brightness level achieved using power only from the primary power source.

20. The display device according to claim 10, wherein the boosted level of illumination increases an amount of a brightness level of a scene being displayed compared to a brightness level achieved using power only from the primary power source.
